(19) United States
(12) Patent Application Publication
(10) Pub. No.: US 2010/0250608 A1
(43) Pub. Date: Sep. 30, 2010

(54) CREATION AND MANAGEMENT OF MULTI-TENANT APPLICATION SERVICES

(75) Inventors: Pankaj Malviya, Sunnyvale, CA (US); Udayakumar Shanmugam, Milpitas, CA (US); Bouvanesvary Radakichenan, Milpitas, CA (US); Neeraj Malviya, Indore (IN); Harshad Chavan, Sunnyvale, CA (US); Aparna Bejugam, Milpitas, CA (US); Krunal Patel, Santa Clara, CA (US); Suresh Malamanti, San Jose, CA (US)

Correspondence Address: CARR & FERRELL LLP, 2200 GENG ROAD, PALO ALTO, CA, 94303, US

(73) Assignee: Relational Networks, Inc., Sunnyvale, CA (US)

(21) Appl. No.: 12/750,620

(22) Filed: Mar. 30, 2010

Related U.S. Application Data
(60) Provisional application No. 61/165,326, filed on Mar. 31, 2009.

(51) Int. Cl. G06F 17/30

(52) U.S. Cl. 707/792; 707/793; 707/E17.005; 707/E17.055

(57) ABSTRACT

Systems and methods for providing application services to multiple tenants are provided. A data model is received from a new tenant. A database specific to the new tenant is created and stored in memory. The database may include one or more metadata tables. Other databases, each associated with another tenant, may also be stored in memory. The data model received from the new tenant may be stored in the created database that is specific to the new tenant. An application service may be provided to the new tenant based on the data model received from the new tenant and stored in the created database. In some embodiments, the data structures may be maintained in memory in a hierarchical manner. The hierarchy of the information resources may further correspond to a hierarchy of tenants. A library, for example, may be organized and shared in a hierarchical manner, in which a hierarchy of library resources may be shared among a defined group of tenants and/or subtenants.

### CROSS-REFERENCE TO RELATED APPLICATIONS

The present application claims the priority benefit of U.S. provisional patent application 61/165,326 filed Mar. 31, 2009, the disclosure of which is incorporated herein by reference.

### BACKGROUND OF THE INVENTION

1. Field of the Invention

The present invention generally relates to application services. More specifically, the present invention relates to creation and management of multi-tenant application services.

2. Description of the Related Art

Presently available software may be provided as a product to users. The amount and degree of use, however, may differ from user to user. For example, one user may only use the software a few times and for only a few tasks, while another user may use the software extensively and take advantage of multiple features thereof. Both users, however, may have paid the same price or fee to use the software product. The difficulty for developers of such a software product is how to market and price the software product so as to maximize a market that may consist of casual and heavy users.

In addition, the use of web-based applications is also becoming more prevalent. Users are becoming more accustomed to obtaining immediate results by downloading, provisioning, and promptly launching an application on their computing devices. Businesses with an online presence or who wish to have an online presence may need to respond to such expectations from their customers. The industry focus of a particular business, however, may not necessarily be related to computing or online services. For example, a manufacturer or retailer may be in the business of selling a particular product. Their customers, however, may have come to expect the ability to learn about and buy such products online using their desktop computers, their mobile devices, and/or through blog and microblog sites. A particular retailer may therefore need to hire teams of developers, designers, engineers, e-commerce specialists, etc., to develop the tools that enable the delivery of their product/service to customers.

While such a model may be profitable for the developers, such a solution may be costly, time-consuming, and not scalable. Many platforms exhibit the same or very similar sets of features (e.g., menus, tables, tabs, secure payment systems), but each one may have been developed and paid for separately. Many businesses, however, may be reluctant to share such costs due to concerns about privacy, confidentiality, and protecting trade secrets.

Even businesses (e.g., software developers) with the ability to develop their own webpages and platforms may not wish to devote significant financial and human resources to such a task. For example, a developer of video games may wish to focus their resources on developing new game titles, developing new game features, etc.—addressing core business challenges and product/service development rather than the challenges of deploying or delivering the same.

There is therefore a need in the art for improved systems and methods for providing application services.

### SUMMARY OF THE CLAIMED INVENTION

Systems and methods for providing application services to multiple tenants are provided. A data model is received from a new tenant. A database specific to the new tenant is created and stored in memory. The database may include one or more metadata tables. Other databases, each associated with another tenant, may also be stored in memory. The data model received from the new tenant may be stored in the created database that is specific to the new tenant. An application service may be provided to the new tenant based on the data model received from the new tenant and stored in the created database.

Embodiments of the present invention provide for methods for providing application services to multiple tenants. Such a method may include receiving a data model from a new tenant, creating a database specific to the new tenant in memory along with other databases specific to other tenants, storing the received data model in the created database, and providing an application service to the tenant based on the received data model. The application services may be provided as a portable package. The application services may further include options for managing all aspects of the tenant including object definitions, data policies, workflows, web forms, validations, layouts, publication, and related databases.

Further embodiments of the method for providing multi-tenant application services may include receiving a requirement where the database specific to the new tenant may include metadata tables and storing the new tenant data and requirement in a database along with data associated with other tenants. While data for multiple tenants may be stored in one database, the data specific to each tenant may remain confidential from the other tenants.

Embodiments of the present invention may further include computer-readable storage media having embodied thereon programs for performing methods for providing application services to multiple tenants.

### BRIEF DESCRIPTION OF THE DRAWINGS

FIG. 1 illustrates an exemplary network in which a system for providing application services to multiple tenants may be implemented.

FIG. 2A illustrates an exemplary database according to an embodiment of the present invention.

FIG. 2B illustrates an exemplary database according to another embodiment of the present invention.

FIG. 3 is a flowchart illustrating an exemplary method for providing application services to multiple tenants.

### DETAILED DESCRIPTION

Systems and methods for providing application services to multiple tenants are provided. A data model is received from a new tenant. A database specific to the new tenant is created and stored in memory. The database may include one or more metadata tables. Other databases, each associated with another tenant, may also be stored in memory. The data model received from the new tenant may be stored in the created database that is specific to the new tenant. An application service may be provided to the new tenant based on the data model received from the new tenant and stored in the created database.

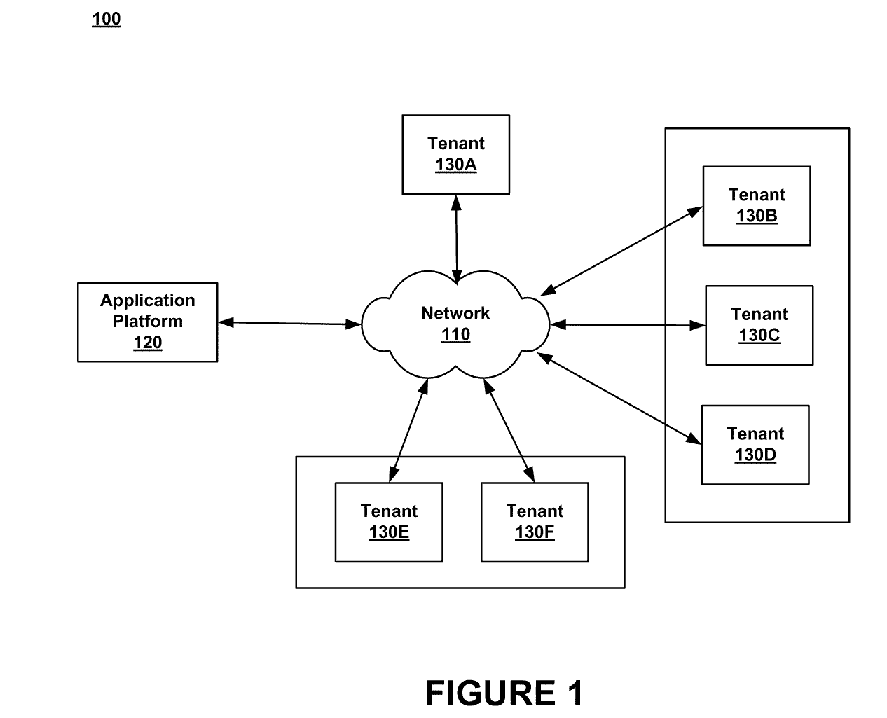

FIG. 1 illustrates an exemplary network environment 100 in which a system for providing application services to multiple tenants (e.g., Tenants 130A-130F) may be implemented. Network environment 100 includes communication network 110, application platform 120, and tenants 130A-130F. Application service provider 120 and tenants 130A-130F may communicate with each other via communication network 110.

Communication network 110 may be a local, proprietary network (e.g., an intranet) and/or may be a part of a larger wide-area network. The communications network 110 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network 110 allows for communication between the various components of network environment 100.

Application service provider 120 provides a platform for development, deployment, and delivery of application services. Application service provider 120 may reside on one or more servers or any computing device as is known in the art, including standard computing components such as network and media interfaces, computer-readable storage (memory), and processors for executing instructions that may be stored in memory. The functionalities of multiple servers may be integrated into a single server. Any of the aforementioned servers (or an integrated server) may take on certain client-side, cache, or proxy server characteristics. These characteristics may depend on the particular network placement of the server, or certain configurations of the server.

Tenants 130 may be any entity that wishes to avail themselves of the resources of application service provider 120. Each tenancy may represent a single user (e.g., tenant 130A) or multiple users (e.g., tenants 130B-D and tenants E-F) who may be part of a company, corporation, or other entity. For example, one tenancy may represent a particular department of a company, while another tenancy may represent another department. A user may communicate with and thereby access the resources at application service provider 120 by using one of any number of different electronic client or end-user devices such as a general-purpose computer, mobile device such as a cellular phone, a personal digital assistant (PDA), as well as a laptop, a netbook (i.e., a miniature laptop computing device), or tablet computing device. Tenants 130 may be configured to access data from other storage media such as memory cards or disk drives as may be appropriate in the case of downloaded content. A tenant 130 is likewise inclusive of any device capable of receiving primary and/or ancillary content over a network or through some other communications operation such as a synchronization operation with another computing device via an ad hoc communications network, storing that content locally at the tenant 130 or at a storage device coupled to the tenant 130, and exchanging data with a server configured for such exchanges. This may include exchanges with application service provider 120.

Each tenant 130 may be associated with a unique identifier. A tenant 130 may be registered either manually or through an exchange of data over network 110. The tenant 130 may be identified thereafter by reference to the identifier, a corresponding user identifier, or both. Tenant 130 includes standard computing components such as network and media interfaces, computer-readable storage (memory), and processors for executing instructions that may be stored in memory.

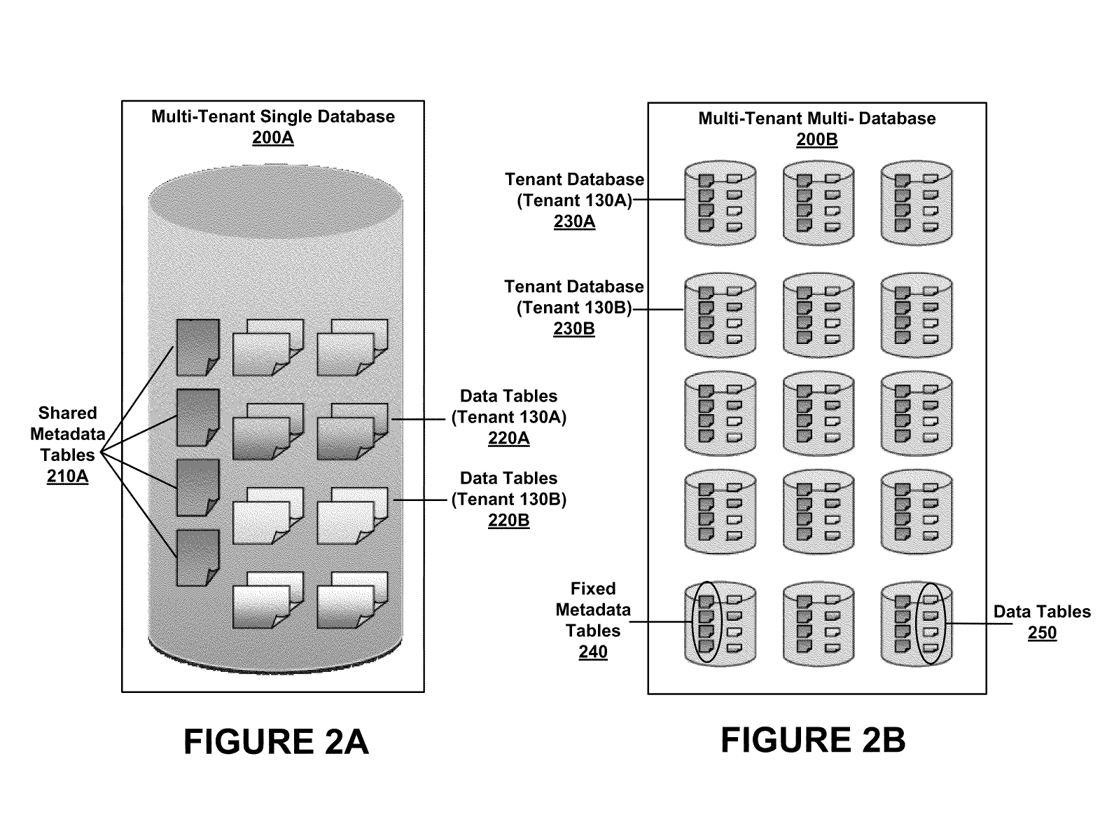

For application service provider 120 to provide resources to each tenant 130, the application service provider may require certain data regarding its tenants. Tenant data may be stored and organized in a single multi-tenant database 200A (FIG. 2A) or a multi-tenant multi-database structure 200B (FIG. 2B).

FIG. 2A illustrates an exemplary database 200A according to an embodiment of the present invention. Database 200A is a single database in which information related to multiple tenants may reside. Database 200A includes shared metadata tables 210A and data related to each tenant. For example, tenant 130A may have provided certain data that is stored in data tables (e.g., data tables 220A-220B) in database 200A. Data table 220A may store data specific to tenant 130A, while data table 220B may store data specific to tenant 130B, and so on. Because information (e.g., metadata) may be shared by multiple tenants, confidentiality and privacy measures may be applied so that data associated with particular tenants is not accessible to any other tenant.

FIG. 2B illustrates an exemplary database 200B according to another embodiment of the present invention. Database 200B is a collection of multiple databases (e.g., tenant databases 230A-230B), each of which includes a fixed metadata table and tenant data specific to the particular tenant. For example, tenant database 230A stores metadata and data specific to tenant 130A, while tenant database 230B stores metadata and data specific to tenant 130B, and so on. Each tenant is therefore associated with a particular database within the larger database 200B. Each database includes fixed metadata tables 230 and data tables 240. Tenant database 230A, which is specific to tenant 130A, therefore includes fixed metadata tables 230 that are specific to tenant 130A, as well as data tables 240 that are specific to tenant 130A.

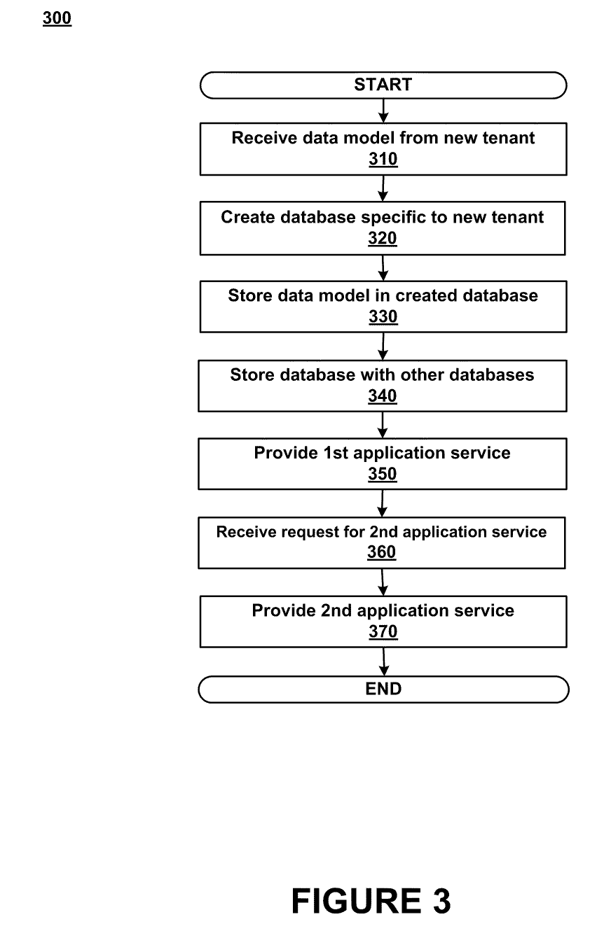

FIG. 3 is a flowchart illustrating an exemplary method for providing application services to multiple tenants. In the method, a data model is received from a new tenant, a database is created specific to the new tenant, the received data model is stored in the database in memory along with other databases specific to other tenants, and an application service is provided to the new tenant based on the data model received and stored in the database specific to the new tenant.

In step 310, a data model is received from a new tenant. The data model may be provided via keyboard entry, as part of a wizard, by email, etc. Depending on the needs of the new tenant, the data model may be provided in a form with particular data fields corresponding to the new tenant needs. For example, a new tenant may wish to use the resources application service provider 120 for the purpose of publishing a type of report. As such, the data model provided by the new tenant may include the types of layouts, headers, sidebars, color scheme, tables, graphs, etc., that the new tenant wishes to include in the report.

Data models may also includes webpage layouts. A rule may be generated based on the data model information received in step 310, such that the execution of the rule configures a webpage to appear as designated by the input. When the rule is applied to a plurality of other applications services provided to the customer, webpages associated with any such application services may be configured to appear as designated by the data model information. The data model information concerning the layout may be chosen from a menu of one or more preconfigured layouts available to the customer. Each preconfigured layout may be associated with a set of one or more predetermined rules.

In step 320, a data structure specific to the new tenant is created. In a single database such as database 200A illustrated in FIG. 2A, a data table (e.g., data table 220A) may be created for the new tenant. In a multi-database such as database 200B illustrated in FIG. 2B, a tenant database 230A may be created for the new tenant. As such, a portion of memory may be allocated to the new tenant, and a particular data structure may be created in the allocated memory to hold information specific to the new tenant.

In step 330, the data model provided by the new tenant in step 330 is stored in the created data structure (e.g., data table 220A or database 230A). In some instances, metadata may also be created and associated with the new tenant. For example, the metadata tables in database 200A may or may not already include a particular style of report or layout for the report. Where database 200A may not include the report style, new metadata tables or fields may be created and shared with other tenants. Similarly, in database 200B, the data model information provided by the new tenant may be saved to, e.g., tenant database 230A, either in the fixed metadata table 240 or data tables 250.

Metadata may also define certain objects. Stored metadata defining the object may be stored and accessed upon receipt of a request for information concerning the object. Specifically, one or more fields of the database may be searched for information related to the designated object upon request, and a display may be generated regarding the information found in the search.

In step 340, the data structures are maintained in memory along with other databases associated with other tenants. Both database 200A and database 200B can hold data structures associated with multiple tenants. Multi-tenancy may allow for common information, including fixed metadata tables that are shared or metadata tables that are repeated in each tenant database.

In some embodiments, the data structures may be maintained in memory in a hierarchical manner. The hierarchy of the information resources may further correspond to a hierarchy of tenants. For example, a company that is a tenant may include multiple departments, each of which may also be associated with its own tenancy. As such, the tenancy may have a hierarchy in which the company tenant is upstream from a department tenant, and a department tenant is downstream from the company tenant. Any resource accessible by the downstream tenant (e.g., department) may also be accessible by an upstream tenant (e.g., company). A resource of an upstream client (e.g., company) may also be organized into discrete portions, which may or may not be made available to a particular downstream client. For example, application service provider 120 may provide a central library accessible to all tenants 130. A portion of that central library may be allocated to and hosted for the benefit of a particular company tenant. Further, a portion of the hosted library may be shared and accessible to a department tenant downstream from the company tenant. Updates (e.g., bug fixes or added features) to a central or upstream resource may therefore result in updates to the relevant tenants (and subtenants) immediately.

A notification concerning updates to the application service may be sent to every tenant 130 currently subscribed to the application service. In addition, a tenant (e.g., tenant 130A) may send a request for the update, in which case the updated data model is sent to the database (e.g., tenant database 230A) associated with the tenant 130A, wherein the application service may then be provided based on the updated data. In further embodiments, the updated data associated with the application service may be sent directly to each of the plurality of databases to allow the updated application service to be provided to the customer.

In step 350, an application service is provided to the new tenant. Using the information provided and stored in the created database specific to the tenant (e.g., database 230A), the application service(s) may be customized and provided to the specifications of the tenant.

In step 360, a request is received for a second application service. The new tenant may wish to add another application service. For example, the new tenant may wish to generate a different type of report. To provide the second application service, the new tenant may or may not have to add information to the data model previously provided in step 310. For example, the report may concern different types of information and may therefore call for a different type of layout, charts, tables, etc. Where providing the second application service requires additional information, the new tenant may be queried regarding the requisite information.

Where providing the second application service does not require information other than that provided in step 310, the second application service may be provided to the new tenant in step 370. The second application service may use or refer to the same resources, metadata, and data tables associated with the tenant 130A. Because the information is already stored in memory, the provisioning, delivery, etc., of the second application service may be expedited.

The present invention may be implemented in an application that may be operable using a variety of end user devices. The present methodologies described herein are fully intended to be operable on a variety of devices. The present invention may also be implemented with cross-title neutrality wherein an embodiment of the present system may be utilized across a variety of titles from various publishers.

Computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of computer-readable media include, for example, a floppy disk, a flexible disk, a hard disk, magnetic tape, other magnetic storage media, a CD-ROM disk, digital video disk (DVD), any other optical medium, RAM, PROM, EPROM, a FLASHEPROM, any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method for providing application services to multiple tenants, the method comprising:
receiving a data model from a new tenant;
creating a database specific to the new tenant, the database comprising one or more metadata tables stored in memory;
storing the data model received from the new tenant in the created database in memory, wherein a plurality of databases are stored in memory, each database associated with a specified tenant and a data model from the specified tenant; and
providing an application service to the new tenant based on the data model received from the new tenant and stored in the created database.

2. The method of claim 1, further comprising:
sending a notification concerning updated data associated with the application service, the notification sent to the tenant associated with each of the plurality of databases;
receiving and processing a request for updating the data model from a tenant; and
sending the updated data model to the database associated with the tenant, wherein the application service is provided based on the updated data.

3. The method of claim 1, further comprising sending updated data to the application service to each of the plurality of databases, wherein the application service is provided based on the updated data.

4. The method of claim 1, wherein a first application service is provided to the new tenant and further comprising:
storing the information regarding the provided first application service in the database specific to the new tenant;
receiving from the new tenant a request for a second application service; and
providing the second application service to the new tenant based on at least the information associated with the first application and stored in the database specific to the new tenant.

5. The method of claim 1, further comprising
receiving input associated with the new tenant, the input concerning a layout of a first webpage;
determining a rule based on the input, wherein the execution of the rule configures the first webpage to appear as designated by the input;
storing the rule in the database specific to the new tenant; and
applying the rule to a plurality of other applications services provided to the new tenant, wherein one or more webpages associated with any of the plurality of other application services is configured to appear as designated by the input.

6. The method of claim 5, wherein the input concerning the layout designates one or more layouts from a plurality of preconfigured layouts available to the new tenant and wherein each preconfigured layout is associated with a set of one or more predetermined rules.

7. The method of claim 1, further comprising:
storing in the database specific to the new tenant information concerning one or more objects, the information including meta information defining the one or more objects;
receiving a request for information concerning a first object;
searching one or more fields of the database specific to the new tenant, the search seeking information related to the first object designated in the received request; and
generating a display of the information found in the search, the display being based on the one or more fields of the database associated with the information found in the search.

8. The method of claim 7, further comprising:
representing components of the first object as a data set in XML (extensible markup language) format, the components comprising layouts, fields, validations, policies, and workflows;
storing the XML set as a comprehensive data set inside the database specific to the new tenant;
adding a version number to the data set; and
rolling back to a previous version of the first object upon request.

9. A computer-readable storage medium, having embodied thereon a program, the program being executable by a processor to perform a method for providing application services to multiple tenants, the method comprising:
receiving at least one data model from a new tenant;
creating a database specific to the new tenant, the database comprising one or more metadata tables;
storing the data model received from the new tenant in the created database, wherein a plurality of databases are also stored, each database associated with a specified tenant; and
providing an application service to the new tenant based on the data model received from the new tenant and stored in the created database.

10. The computer-readable storage medium of claim 9, further comprising instructions executable to:
send a notification concerning updated data model to the application service to tenants associated with each of the plurality of databases;
receive and process a request for updating the data model from a tenant; and
send the updated data model to the database associated with the tenant, wherein the application service is provided based on the updated data model.

11. The computer-readable storage medium of claim 9, further comprising instructions executable to send updated data model to the application service to each of the plurality of databases, wherein the application service is provided based on the updated data model.

12. The computer-readable storage medium of claim 9, further comprising instructions executable to:
store information associated with the first application service in the database specific to the new tenant;
receive from the new tenant a request for a second application service; and
provide the second application service to the new tenant based on at least the information associated with the first application and stored in the database specific to the new tenant.

13. The computer-readable storage medium of claim 9, further comprising instructions executable to:
receive input associated with the new tenant, the input concerning a layout of a first webpage;
determine a rule based on the input, wherein the execution of the rule configures the first webpage to appear as designated by the input;
store the rule in the database specific to the new tenant; and
apply the rule to a plurality of other applications services provided to the new tenant, wherein one or more webpages associated with any of the plurality of other application services is configured to appear as designated by the input.

14. The computer-readable storage medium of claim 9, wherein the input concerning the layout designates one or more layouts from a plurality of preconfigured layouts available to the tenant and wherein each preconfigured layout is associated with a set of one or more predetermined rules.

15. The computer-readable storage medium of claim 9, further comprising instructions executable to:
store in a database specific to the new tenant information concerning one or more objects, the information including meta information defining the one or more objects;
receive a request for information concerning a first object;
search one or more fields of the database specific to the new tenant, the search seeking information related to the first object designated in the received request; and
generate a display of the information found in the search, the display being based on the one or more fields of the database associated with the information found in the search.

16. A method for providing application services to multiple tenants, the method comprising:
receiving at least one data model and requirement from a new tenant;
creating a database specific to the new tenant, the database comprising one or more metadata tables stored in memory;
storing the data model received from the new tenant in the created database, the database being further associated with a plurality of other tenants, wherein data specific to each tenant remains confidential from the plurality of other tenants; and
providing an application service to the new tenant based on the data model received from the new tenant and stored in the created database.

17. The method of claim 16, further comprising maintaining in memory a set of libraries, each library comprising resources for extending functionality of a service.

18. The method of claim 17, wherein the set of libraries is organized in a hierarchy comprising a plurality of tiers, wherein a first tier is accessible to a set of the plurality of tenants associated with the database and a second tier is accessible to a subset of the set, the second tier being downstream from the first tier.

19. The method of claim 18, wherein an update to a library immediately updates the functionality for the set of the plurality of tenants having access to the library.

20. A method for providing application services to multiple tenants, the method comprising:
maintaining in memory a set of libraries, each library comprising resources for extending functionality of a service;
organizing the set of libraries in memory, wherein the set of libraries is organized in a hierarchy comprising a plurality of tiers, wherein a first tier is accessible to a set of the plurality of tenants associated with the database and a second tier is accessible to a subset of the set, the second tier being downstream from the first tier;
receiving an update concerning a library in the set of libraries; and
updating a service functionality in the library in accordance with the received update. wherein the service functionality is updated for the set of the plurality of tenants having access to the library.
